(19) United States
(12) Patent Application Publication
(10) Pub. No.: US 2025/0111209 A1
(43) Pub. Date: Apr. 3, 2025

(54) COLLABORATIVE PROMPT BUILDING FOR GENERATIVE AI MODELS

(71) Applicant: International Business Machines Corporation, Armonk, NY (US)

(72) Inventors: Gennaro Anthony Cuomo, Durham, NC (US); Luis Fernando Munoz, Centennial, CO (US); Blaine H. Dolph, Western Springs, IL (US); Christopher Hay, Great Horkesley (GB)

(21) Appl. No.: 18/477,596

(22) Filed: Sep. 29, 2023

(51) Int. Cl. G06N 3/0475

(52) U.S. Cl. CPC G06N 3/0475

(57) ABSTRACT

Aspects of the invention include techniques for collaborative prompt building for generative artificial intelligence models. A non-limiting example method includes receiving, from a client, a prompt for a large language model. A decision tree is built to determine one or more decision points for refining the prompt and a knowledge graph is built having one or more nodes associated with a feature of the prompt. The method includes delivering, to the client, a challenge comprising a query associated with at least one of the one or more decision points and the one or more nodes, receiving, from the client, an answer to the challenge, and delivering, to the client, a refined prompt by modifying the prompt using the answer to the challenge.

### BACKGROUND

The present invention generally relates to generative artificial intelligence, and more specifically, to computer systems, computer-implemented methods, and computer program products for collaborative prompt building for generative artificial intelligence (GAI) models.

A GAI model is a type of artificial intelligence system designed to generate content, such as text, images, or even music, that is contextually relevant, coherent, and often indistinguishable from content created by humans. For example, in the case of text generation, a GAI model might take a sentence or a few words as input and then generate a coherent paragraph or article that continues from that input in a way that makes sense. These models have found applications in various fields, including natural language processing, content creation, chatbots, image generation, and more.

GAI models, such as Large Language Models (LLMs) and their foundational architectures, operate on the principle of deep learning, utilizing neural networks with millions, or even billions, of parameters. At their core, these models often rely on a process known as unsupervised learning, where they are trained using vast amounts of text data to learn the underlying patterns, grammar, and semantics of human language. Through this extensive training, GAI models acquire the ability to predict the most likely next word or phrase in a given context. A contextually relevant, coherent output can be created by repeatedly generating the next most likely word (or next token). These models have demonstrated remarkable versatility, excelling in tasks ranging from language translation and sentiment analysis to content generation and question answering.

### SUMMARY

Embodiments of the present invention are directed to techniques for collaborative prompt building for generative artificial intelligence models. A non-limiting example method includes receiving, from a client, a prompt for a large language model. A decision tree is built to determine one or more decision points for refining the prompt and a knowledge graph is built having one or more nodes associated with a feature of the prompt. The method includes delivering, to the client, a challenge comprising a query associated with at least one of the one or more decision points and the one or more nodes, receiving, from the client, an answer to the challenge, and delivering, to the client, a refined prompt by modifying the prompt using the answer to the challenge.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computing environment for use in conjunction with one or more embodiments;

FIG. 2 depicts a block diagram of components of the prompt facilitator of FIG. 1 in accordance with one or more embodiments;

FIG. 3 depicts a block diagram of an example user interface for collaborative prompt building in accordance with one or more embodiments; and

FIG. 4 depicts a flowchart in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified.

In the accompanying figures and following detailed description of the described embodiments of the invention, the various elements illustrated in the figures are provided with two or three-digit reference numbers. With minor exceptions, the leftmost digit(s) of each reference number correspond to the figure in which its element is first illustrated.

### DETAILED DESCRIPTION

Generative artificial intelligence (GAI) models possess the remarkable ability to autonomously generate coherent and contextually relevant text, often indistinguishable from human-authored content. Central to their operation is the prompt. A prompt is a short piece of text used to guide the GAI model in generating a larger piece of text. In other words, a prompt acts as an input or instruction provided to the model, setting the context and direction for its output. The choice and quality of prompts significantly impacts the quality of any output generated by these models. Therefore, crafting effective prompts is a skill that demands a deep understanding of language, context, and desired outcomes.

Unfortunately, creating an effective, high-quality prompt is not always straightforward. Often, creating a high-quality prompt for a GI model is a multifaceted task that involves a number of factors, such as linguistic expertise, context comprehension, and a deep understanding of the desired outcomes. The complexity of the task, along with the need for clarity and relevance, makes prompt creation a challenging but crucial aspect of harnessing the full potential of GAI models. Some example difficulties are clarity and specificity (the prompt needs to be clear and specific in conveying the desired task or context to the model-ambiguous or vague prompts can lead to unpredictable or irrelevant outputs), contextual relevance (crafting a prompt that establishes the right context and provides sufficient information to ensure that the output aligns with the intended context), language understanding (effective prompts require a deep understanding of language nuances, grammar, and semantics), task complexity (the complexity of the task can affect prompt quality-some tasks may require more elaborate prompts, while others can be addressed with simpler instructions), domain knowledge (certain tasks may require domain-specific knowledge to create effective prompts, for instance, medical or legal applications may demand specialized expertise), and user variability (different users may respond differently to prompts, so considerations for user diversity and adaptability are important), among others.

This disclosure introduces new methods, computing systems, and computer program products for collaborative prompt building for generative artificial intelligence models. Rather than simply relaying on a single user providing a one-shot prompt input to a GAI, described herein is a dynamic, collaborative prompt facilitator that leverages the principle of diversity of thought and roles to identify and task participants with different personas (e.g., developer, designer, security) to collaborate to build a respective prompt within a self-guided, team-based, collaborative prompt building architecture. The principle of diversity of thought and roles suggests that having a diverse group of people with different backgrounds, experiences, and perspectives can lead to better outcomes. This principle applies to prompt engineering in GAI models, as a diverse team can bring a wider range of perspectives and expertise to the task of prompt building. By leveraging the principle of diversity of thought and roles, the system enables multiple users to work cooperatively on a prompt, resulting in better outcomes (i.e., the creation of high-quality prompts with greater ease and efficiency).

In some embodiments, the self-guided process can include an AI-based facilitator that brings together individuals with varying specialties and roles to cultivate a collaborative environment where multiple perspectives are shared and combined to produce high-quality prompts. This approach helps to establish a clear understanding of what a good prompt and result entail, based on good practices such as being unbiased, energy-efficient, and cost-effective. Additionally, the AI-based facilitator is embodied within a distinct user interface that challenges prompt creators through questions and suggestions and invites collaborators with diverse personas to produce the most optimal prompt and outcome.

In some embodiments, the combination of decision trees, knowledge graphs, and neural networks in the collaborative prompt facilitator provides a more effective solution for prompt engineering in GAI models. Decision trees help identify key decisions required to generate high-quality results, knowledge graphs ensure that those decisions accurately reflect the key concepts and relationships within the prompt, and neural networks capture those decisions and generate high-quality results. By leveraging these three systems and/or algorithms and the collective expertise of a diverse team, the system can achieve the best possible outcomes.

A collaborative prompt building architecture that leverages the principle of diversity of thought and roles within a self-guided process in accordance with one or more embodiments described herein offers various technical advantages over prior approaches to GAI model prompt generation. In short, the present models can leverage this team-based approach to create high-quality prompts efficiently and effectively. The system includes a self-guided process facilitated by an AI-based facilitator, which combines decision trees, knowledge graphs, and neural network algorithms, as well as a unique user interface, in a new way to guide a group of users through one or more AI-generated questions and recommendations, including selecting additional collaborators, to improve prompt quality (and therefore GAI model output). By leveraging the collective expertise of a diverse team, the system enables users to create high-quality prompts more efficiently and effectively. In some embodiments, the system enables input prompts to be refined by leveraging a knowledge graph to find additional users having specific characteristics that would be useful and/or necessary to improve the prompt.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

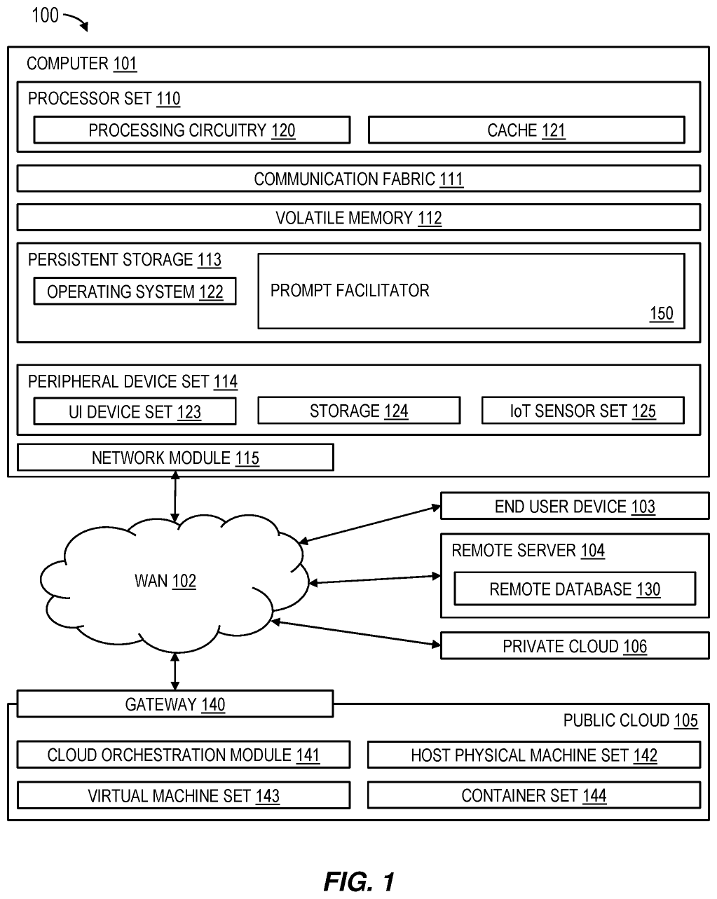

Referring now to FIG. 1, computing environment 100 contains an example of an environment for the execution of at least some of the computer code involved in performing the inventive methods, such as prompt facilitator 150 (also referred to herein as block 150 and/or as a prompt building system). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

It is to be understood that the block diagram of FIG. 1 is not intended to indicate that the computing environment 100 is to include all of the components shown in FIG. 1. Rather, the computing environment 100 can include any appropriate fewer or additional components not illustrated in FIG. 1 (e.g., additional memory components, embedded controllers, modules, additional network interfaces, etc.). Further, the embodiments described herein with respect to the computing environment 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

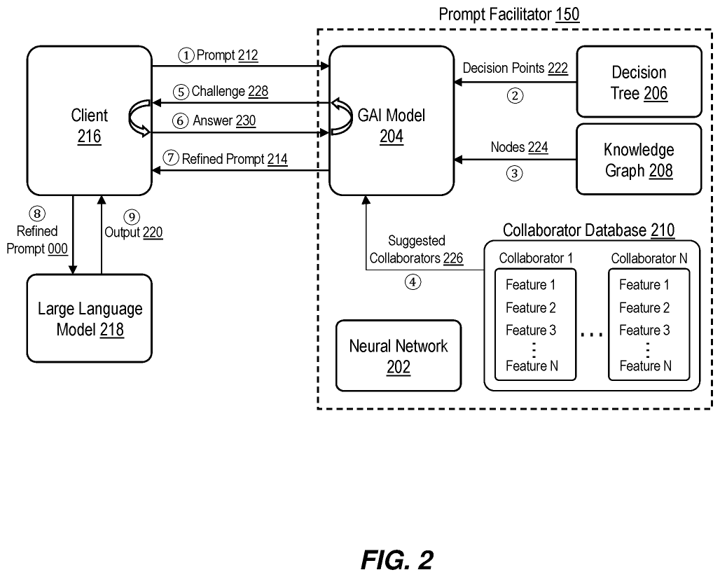

FIG. 2 depicts a block diagram of components of the prompt facilitator 150 of FIG. 1 according to one or more embodiments described herein. In some embodiments, the prompt facilitator 150 includes a neural network 202, a generative artificial intelligence (GAI) model 204, a decision tree 206, a knowledge graph 208, and a collaborator database 210. In some embodiments, the prompt facilitator 150 is configured to receive an input prompt 212 and output, responsive to receiving the input prompt, a refined prompt 214. In some embodiments, the prompt facilitator 150 is configured for collaborative prompt building. An illustrative workflow for collaborative prompt building is now described with reference to FIG. 2.

At Step 1, the prompt facilitator 150 receives the prompt 212. In some embodiments, the prompt 212 is passed to the GAI model 204. In some embodiments, the prompt 212 is provided from a client 216. The client 216 can include an external system(s) (e.g., a user terminal such as the end user device 103 in FIG. 1) and is not meant to be particularly limited. In some embodiments, the prompt 212 is a piece of text (also referred to as a string of text) that serves as an input and/or instruction provided to a large language model 218 to guide the large language model 218 in generating a larger piece of text (here, the output 220).

The content of the prompt 212 can vary in length and complexity and is not meant to be particularly limited, but is essentially a textual cue that can convey the context, task, and/or desired information for the output 220 generated by the large language model 218. For example, if a user desires the large language model 218 to write a summary of a news article, the prompt 212 might be a sentence like: “Please provide a concise summary of the following news article.” In another example, the prompt 212 might include the text “Write me a story about a boy who loses his toy.”

At Step 2, the prompt facilitator 150, the GAI model 204, and/or the decision tree 206 determines one or more key decision points 222 which would be helpful in refining the prompt 212. In some embodiments, a decision point 222 includes a specific characteristic and/or choice relevant to the prompt 212 that benefits from careful consideration and that, when answered, improves the generation of the refined prompt 214. In some embodiments, a decision point 222 can be answered to ensure that the prompt 212 effectively conveys the proper context, instructions, and/or expectations to the large language model 218, leading to improved results. While not meant to be particularly limited, a decision point 222 can include, for example, a request for contextual information, such as any data, facts, and/or references necessary and/or helpful in determining the correct content, context, and/or background for the prompt 212, a request to select a style, voice, and/or tone for the desired output 220, a request for additional specific or general input data, a request to specify one or more constraints for the output 220, such as the desired length of the output 220 and/or the identification of any limitations on the output 220, and/or a request for examples or references having a content, context, and/or style that should be emulated. In some embodiments, the decision points 222 are provided to the GAI model 204.

In some embodiments, the decision points 222 are determined from the decision tree 206 (although other algorithmic approaches are possible). In some embodiments, the neural network 202 is trained to build a decision tree 206 that identifies key features and patterns (e.g., the decision points 222) that are important for generating a high-quality refined prompt 214. In some embodiments, the neural network 202 is trained to build a decision tree 206 from one or more features and/or characteristics of the prompt 212. In some embodiments, the neural network 202 is trained on a large dataset (thousands, hundreds of thousands, millions of prompts) using reinforcement learning with human feedback (RLHF) to build the decision tree 206. RLHF is a machine learning approach that combines reinforcement learning techniques with human feedback to train and improve the performance of AI models. In RLHF, an AI agent interacts with an environment and receives feedback from humans to learn and refine its behavior. For example, a team of collaborators can fine-tune the neural network 202 using RLHF to identify the features and patterns which were empirically more helpful in generating a high-quality refined prompt 214.

In some embodiments, the neural network 202 might learn that prompts related to the concept “story” require a “setting” and a “resolution”, that a theme of “love” and/or “fun” generates more positive feedback for output directed towards children, that a poem with a particular style or mood (e.g., “peaceful”) generates more positive feedback in particular contexts, etc. In some embodiments, the neural network 202 can build the decision tree 206 by connecting one or more nodes (not separately shown), each representing a decision point 222. In some embodiments, the decision points 222 are a plurality of two or more sequential steps (refer to “Example Decision Tree”).

Continuing from the previous example, responsive to receiving the prompt 212 including the text “Write me a story about a boy who loses his toy,” the prompt facilitator 150, the GAI model 204, and/or the decision tree 206 can determine a number of appropriate decision points 222 such as, for example, determining the “genre,” “setting,” “characters,” “clues”, and “resolution” for the generated story. An example decision tree 206 is shown below.

### Example Decision Tree:

| | Decision | |
|---|---|---|
| Step | Points | Action |
| 1 | Genre | Non-fiction, fiction, children's story, |
| | | mystery, classic, coming-of-age, epic, etc. |
| 2 | Setting | Choose a setting for the story (e.g. |
| | | city, small town, countryside). |
| 3 | Characters | Identify one or more people and/or |
| | | animals that the boy (the main |
| | | character) meets along the way. |
| 4 | Clues | Determine the clues that the boy |
| | | will use to solve the case (e.g., |
| | | physical evidence, a noise |
| | | heard from one of the supporting |
| | | characters, etc.) |
| 5 | Resolution | Outline a resolution to the story, |
| | | such as revealing the final |
| | | location of the toy. |

At Step 3, the prompt facilitator 150, the GAI model 204, and/or the knowledge graph 208 identifies and relates one or more concepts and relationships for the prompt 212. In some embodiments, the concepts and/or relationships are represented as nodes 224 within the knowledge graph 208. In some embodiments, the nodes 224 are provided to the GAI model 204.

In some embodiments, the knowledge graph 208 represents one or more concepts and/or relationships within the prompt 212 that must be understood to ensure that the prompt 212 is accurately understood by the large language model 218. For example, a knowledge graph 208 might map out the relationships between different concepts relevant to the creation of a story. This could involve creating a set of related terms and defining how they relate to each other, such as, for example, defining the relationships between “characters,” “settings,” and “plot points” within the context of a story. An example of various nodes 224 in the knowledge graph 208 is provided below:

| Node | Description |
|---|---|
| Ocean | A large body of saltwater that covers |
| | most of the earth′s surface |
| Love | A strong affection or romantic |
| | feeling for someone or something |
| Adventure | An exciting or unusual experience, |
| | often involving risk or danger |
| Mystery | Something that is difficult or |
| | impossible to understand or explain |
| Happy | Feeling or showing pleasure or contentment |
| Sad | Feeling or showing sorrow or unhappiness |
| Peaceful | Free from disturbance; tranquil |
| Exciting | Causing great enthusiasm and eagerness |
| Sonnet | A poem of fourteen lines, usually |
| | in iambic pentameter |
| Haiku | A traditional form of Japanese |
| | poetry consisting of three lines |
| Free verse | Poetry that does not rhyme |
| | or have a regular meter |
| Toy | An object provided for play, typically |
| | by a child, such as a model car or |
| | miniature. |
| Clue | Something discovered that helps a |
| | person find or understand something, |
| | for example, while solving a mystery. |

In some embodiments, the neural network 202 is trained to identify the nodes 224 and/or to build the knowledge graph 208. In some embodiments, the neural network 202 is trained on a large dataset with or without RLHF as described previously to build the knowledge graph 208. In some embodiments, RLHF includes a team of people collaborating to define positive and negative examples of resultant knowledge graphs. In some embodiments, the RLHF element incorporates feedback from a diverse set of perspectives to ensure that the knowledge graph 208 accurately represents the key concepts and relationships within the prompt 212.

At Step 4, the prompt facilitator 150, and/or the neural network 202 identifies one or more suggested collaborators 226 for refining the prompt 212. In this manner, the prompt facilitator 150 can be leveraged to help identify one or more potential collaborators whose expected and/or potential contribution is predicted (within any desired tolerance) to provide a positive refinement of the prompt 212. In some embodiments, the neural network 202 is trained to identify potential collaborators from the collaborator database 210 who can, based on one or more features of the respective collaborator, contribute to the refinement of the prompt 212. As used herein, a “feature” of a collaborator can include their expertise, education, work history, past performance, and/or any other characteristic of interest. As used herein, a collaborator's “past performance” refers to the quality of the prior prompt refinements provided by the respective collaborator for one or more prior prompts.

In some embodiments, the neural network 202 is trained to score the features of the available collaborators found in the collaborator database 210 and to provide, to the GAI model 204, the N suggested collaborators 226 having a highest score and/or the N suggested collaborators 226 having a score greater than a predetermined threshold. In some embodiments, the neural network 202 is trained to identify one or more features of the prompt 212 and to pair those features with the features of the available collaborators found in the collaborator database 210. In some embodiments, a score can be generated for each prompt feature-collaborator feature pair based on a distance measure (e.g., cosine distance, etc.). In some embodiments, a score for a respective collaborator is a function (e.g., average) of the various prompt-feature-collaborator feature pairs.

In some embodiments, the neural network 202 is trained to maximize (and/or generally increase) the diversity of contributing members to the prompt 212. In other words, the neural network 202 can be trained to leverage the principle of diversity of thought and roles to identify and task participants with different personas (e.g., developer, designer, security, etc.) to collaborate to refine the prompt 212 within a self-guided, team-based, collaborative prompt building architecture. In some embodiments, the neural network 202 is trained to score the collaborator features in a manner that maximizes the diversity of contributing members to the prompt 212. For example, a collaborator having a unique feature can be scored higher than a collaborator having features which overlap with other collaborators. In another example, a feature that is unique can be scored higher than features which are common to many collaborators. In this manner, collaborators which offer relative improvements in diversity measures for a given scenario (prompt, list of current collaborators, etc.) can be scored higher for that respective scenario.

In some embodiments, the neural network 202 is trained to adjust the identification of the one or more suggested collaborators 226 responsive to an evolution of the prompt 212 during the collaborative process (that is, along the path between the prompt 212 and the refined prompt 214). For example, as the collaborators answer questions (refer to Step 6) to progressively refine the prompt 212, the neural network 202 can update the features of the prompt 212 and, correspondingly, can rescore the various collaborators in the suggested collaborators and/or the collaborator database 210. Based on this re-scoring, the neural network 202 can suggest potential new collaborators who could improve the prompt 212 even further. For example, the neural network 202 might suggest inviting a linguistics expert to refine a prompt responsive to the prompt evolving during the collaborative process to include a story having a rare dialect.

At Step 5, the prompt facilitator 150 and/or the GAI model 204 constructs and delivers a challenge 228 to the client 216. While not meant to be particularly limited, the challenge 228 can include one or more questions and/or requested clarifications for one or more of the decision points 222 and/or nodes 224. Moreover, the challenge 228 can include a list of one or more suggested collaborators 226 and optionally, the reason(s) for their selection. In other words, once the prompt facilitator 150 and/or the neural network 202 has identified one or more suggested decision points 222 and/or nodes 224, the user can be challenged (tasked) to refine the prompt 212 by answering one or more follow-up questions directed to the decision points 222 and/or nodes 224 that are designed to improve the prompt 212.

Continuing again from the prior example, the challenge 228 might include a series of questions or queries for a user directed to the selection and/or desired “genre,” “setting,” “characters,” “clues”, and “resolution” for the generated story. For example, the challenge 228 can include, based on the decision tree 206 and/or the decision points 222, a set of follow-up questions including, “What time of day should the story take place?”, “What type of type toy is lost?”, “How many people should the boy meet?”, “How many clues should the boy find?”, etc. In some embodiments, the neural network 202 can be trained to design the questions to improve the original prompt 212. For example, a new set of prompts can be identified that, when answered, are predicted to improve the original prompt 212.

At Step 6, the prompt facilitator 150 and/or the GAI model 204 receives, from the client 216, an answer 230 to the challenge 228. While not meant to be particularly limited, the answer 230 can include one or more answers and/or clarifications for one or more of the decision points 222 and/or nodes 224. Continuing again from the prior example, the answer 230 might include the text, “the genre is a fictional children's story, the story takes place in the morning, the toy is a small yellow car, the boy meets two helpful people and 3 helpful animals during his search, and each of them provides a clue.”

In addition, the answer 230 can include the designation and/or selection of one or more new collaborators for refining the prompt 212. The new collaborators can include, but need not be limited to, one or more of the suggested collaborators 226. In addition, the user can identify one or more other collaborators not known or not selected by the neural network 202. Continuing again from the prior example, the answer 230 might identify a User A who is a writer with recent experience in crafting mystery stories.

In some embodiments, when a new collaborator enters the shared prompt engineering space (e.g., is identified in the answer 230), the prompt facilitator 150 is configured to invite the new collaborator to answer one or more questions about the prompt 212. The questions can be derived from the decision tree 206 and/or knowledge graph 208 as described previously with respect to the original user.

In some embodiments, the challenge 228 and the answer 230 iterate (repeat) until all of the questions and/or requested clarifications for one or more of the decision points 222 and/or nodes 224 have been provided. For example, the challenge 228 might only include questions directed to a single decision point 222 of the decision tree 206 and the corresponding answer 230 might include responses primarily relevant to those respective queries. In some embodiments, the challenge 228 and the answer 230 iterate until all of the decision points 222 have been addressed.

At Step 7, the prompt facilitator 150 and/or the GAI model 204 builds and delivers, to the client 216, a refined prompt 214. While not meant to be particularly limited, the refined prompt 214 can include any combination of the new context, characteristics, and/or information determined during the collaborative process (e.g., through any of Step 1 though Step 6).

Continuing again from the prior example, the refined prompt 214 might include the text, “Compose a captivating fictional children's story set in the morning, centered around a young boy who embarks on an exciting adventure to recover his cherished small yellow toy car. The story should begin with the boy realizing that his beloved toy is missing, setting the stage for his quest. As he journeys through a colorful and imaginative world, he encounters two kind-hearted people and three friendly animals, each of whom imparts a vital clue that contributes to the boy's quest to reunite with his treasured toy. Develop the characters, the setting, and the plot in a way that engages young readers and emphasizes the values of determination, kindness, and problem-solving. Ensure a heartwarming resolution where the boy ultimately finds his lost toy car, making it a memorable and inspiring tale for children.”

At Step 8, the user, via the client 216, provides the refined prompt 214 to the large language model 218. At Step 9, the user receives, from the large language model 218, an output 220. Observe that the quality, context, and details within the refined prompt 214 improve over those originally offered in the prompt 212. Accordingly, the quality of the output 220 will be greatly improved.

### Example Use-Cases

While not meant to be particularly limited, a few example use-cases for the prompt facilitator 150 can be illustrative. In one scenario (e.g., healthcare), collaboration between a doctor, a data scientist, and a patient can be facilitated according to one or more embodiments to fine-tune a prompt for a GAI model to diagnose a patient's symptoms. In another scenario (e.g., finance), collaboration between a financial analyst, a UX designer, and a data scientist can be facilitated according to one or more embodiments to fine-tune a prompt for a GAI model to predict stock market trends. In yet another scenario (e.g., human resources), collaboration between an HR manager, a UX designer, and a data scientist can be facilitated according to one or more embodiments to fine-tune a prompt for a GAI model to identify qualified job candidates.

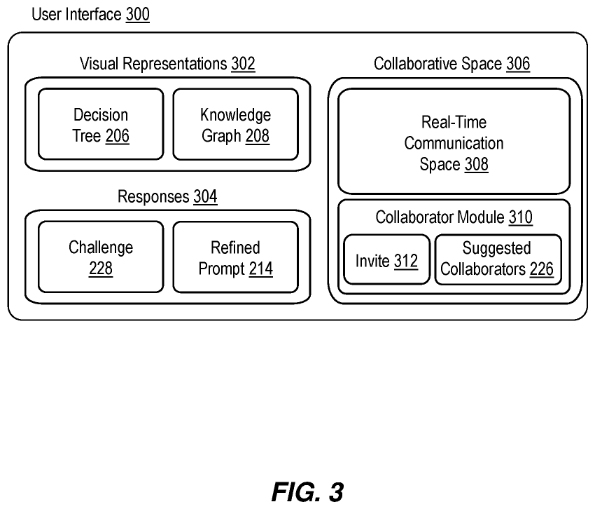

FIG. 3 depicts a block diagram of an example user interface 300 for collaborative prompt building in accordance with one or more embodiments. In some embodiments, the user interface 300 can be incorporated within the client 216 and/or the prompt facilitator 150 (refer to FIG. 2).

In some embodiments, the user interface 300 includes visual representations 302. In some embodiments, the visual representations 302 include a graphical depiction of the decision tree 206 and/or the knowledge graph 208 discussed with respect to FIG. 2. The visual representations of the decision tree 206 and knowledge graph 208 can aid one or more users (collaborators) in better understands the relationships and connections between different elements of the prompt 212.

In some embodiments, the user interface 300 includes responses 304. In some embodiments, the responses 304 include a space and/or text widget for displaying the challenge 228 and/or the refined prompt 214 discussed with respect to FIG. 2.

In some embodiments, the user interface 300 includes a collaborative space 306. In some embodiments, the collaborative space 306 includes a shared real-time communication space 308, such as, for example, a chat and/or messaging interface, for exchanging text and/or data between the collaborators and/or the prompt facilitator 150 (refer to FIG. 2). In some embodiments, the chat and/or messaging interface includes synchronous and asynchronous communication features to enable users to flexibly collaborate to refine the prompt 212. Advantageously, this flexibility allows for faster communication and joint problem-solving, leading to a more seamless and efficient prompt building process. Moreover, asynchronous communication support ensures that users can collaborate at their own pace and convenience (e.g., users from different time zones).

In some embodiments, the collaborative space 306 includes a collaborator module 310. In some embodiments, the collaborator module 310 is configured to manage the identification and selection of collaborators for a collaborative prompt building effort. For example, the collaborator module 310 can include a selectable widget (here, “Invite 312”) and a respective list of suggested collaborators 226. In some embodiments, selecting the widget “Invite 312” results in a dialog or other type of pop-up for selecting a collaborator. In some embodiments, selection of the widget “Invite 312” and/or the follow-up selection of a particular collaborator results in sending (via the prompt facilitator 150 or otherwise), an invite notification to the respective collaborator.

In some embodiments, the collaborative space 306 and/or the shared real-time communication space 308 contains a list of questions derived from the decision tree 206 and/or the knowledge graph 208, which any of the collaborators can answer to help refine the prompt 212. In some embodiments, the collaborative space 306 and/or the shared real-time communication space 308 contains one or more AI-generated recommendations and questions (e.g., any aspect of the challenge 228) to guide a collaborator through the prompt building process, improving the efficiency and quality of the prompts created. Moreover, the real-time communication space 308 enables multiple users to seamlessly work on the same prompt refinement task simultaneously.

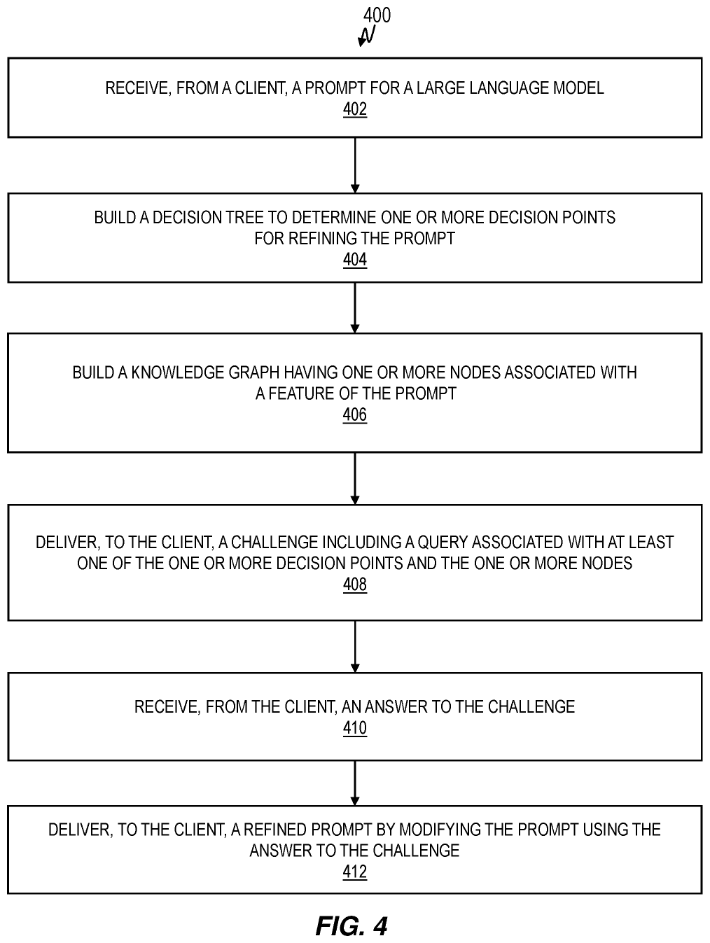

Referring now to FIG. 4, a flowchart 400 for collaborative prompt building for generative artificial intelligence models is generally shown according to an embodiment. The flowchart 400 is described in reference to FIGS. 1-3 and may include additional blocks not depicted in FIG. 4. Although depicted in a particular order, the blocks depicted in FIG. 4 can be rearranged, subdivided, and/or combined. In exemplary embodiments, the flowchart 400 can be performed by a computing environment (e.g., computing environment 100 shown in FIG. 1).

At block 402, the method includes receiving, from a client, a prompt for a large language model.

At block 404, the method includes building a decision tree to determine one or more decision points for refining the prompt.

At block 406, the method includes building a knowledge graph having one or more nodes associated with a feature of the prompt.

At block 408, the method includes delivering, to the client, a challenge including a query associated with at least one of the one or more decision points and the one or more nodes.

At block 410, the method includes receiving, from the client, an answer to the challenge.

At block 412, the method includes delivering, to the client, a refined prompt by modifying the prompt using the answer to the challenge.

In some embodiments, the method includes identifying a suggested collaborator for refining the prompt. In some embodiments, the challenge further includes the suggested collaborator.

In some embodiments, the method includes providing the refined prompt to the large language model. In some embodiments, the method includes receiving, from the large language model, an output generatively built from the refined prompt.

In some embodiments, the method includes receiving, from the client, a designation of a new collaborator for refining the prompt. In some embodiments, the method includes inviting the new collaborator to answer a query associated with at least one of the one or more decision points and the one or more nodes.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving, from a client, a prompt for a large language model;
building a decision tree to determine one or more decision points for refining the prompt;
building a knowledge graph having one or more nodes associated with a feature of the prompt;
delivering, to the client, a challenge comprising a query associated with at least one of the one or more decision points and the one or more nodes;
receiving, from the client, an answer to the challenge; and
delivering, to the client, a refined prompt by modifying the prompt using the answer to the challenge.

2. The computer-implemented method of claim 1, further comprising identifying a suggested collaborator for refining the prompt.

3. The computer-implemented method of claim 2, wherein the challenge further comprises the suggested collaborator.

4. The computer-implemented method of claim 1, further comprising providing the refined prompt to the large language model.

5. The computer-implemented method of claim 4, further comprising receiving, from the large language model, an output generatively built from the refined prompt.

6. The computer-implemented method of claim 1, further comprising receiving, from the client, a designation of a new collaborator for refining the prompt.

7. The computer-implemented method of claim 6, further comprising inviting the new collaborator to answer a query associated with at least one of the one or more decision points and the one or more nodes.

8. A system having a memory, computer readable instructions, and one or more processors for executing the computer readable instructions, the computer readable instructions controlling the one or more processors to perform operations comprising:
receiving, from a client, a prompt for a large language model;
building a decision tree to determine one or more decision points for refining the prompt;
building a knowledge graph having one or more nodes associated with a feature of the prompt;
delivering, to the client, a challenge comprising a query associated with at least one of the one or more decision points and the one or more nodes;
receiving, from the client, an answer to the challenge; and
delivering, to the client, a refined prompt by modifying the prompt using the answer to the challenge.

9. The system of claim 8, the operations further comprising identifying a suggested collaborator for refining the prompt.

10. The system of claim 9, wherein the challenge further comprises the suggested collaborator.

11. The system of claim 8, the operations further comprising providing the refined prompt to the large language model.

12. The system of claim 11, the operations further comprising receiving, from the large language model, an output generatively built from the refined prompt.

13. The system of claim 8, the operations further comprising receiving, from the client, a designation of a new collaborator for refining the prompt.

14. The system of claim 13, the operations further comprising inviting the new collaborator to answer a query associated with at least one of the one or more decision points and the one or more nodes.

15. A computer program product comprising a computer readable storage medium having program instructions embodied therewith, the program instructions executable by one or more processors to cause the one or more processors to perform operations comprising:
receiving, from a client, a prompt for a large language model;
building a decision tree to determine one or more decision points for refining the prompt;
building a knowledge graph having one or more nodes associated with a feature of the prompt;
delivering, to the client, a challenge comprising a query associated with at least one of the one or more decision points and the one or more nodes;
receiving, from the client, an answer to the challenge; and
delivering, to the client, a refined prompt by modifying the prompt using the answer to the challenge.

16. The computer program product of claim 15, further comprising identifying a suggested collaborator for refining the prompt.

17. The computer program product of claim 16, wherein the challenge further comprises the suggested collaborator.

18. The computer program product of claim 15, further comprising providing the refined prompt to the large language model.

19. The computer program product of claim 18, further comprising receiving, from the large language model, an output generatively built from the refined prompt.

20. The computer program product of claim 15, further comprising receiving, from the client, a designation of a new collaborator for refining the prompt.
